(19) United States
(12) Patent Application Publication
(10) Pub. No.: US 2025/0008044 A1
(43) Pub. Date: Jan. 2, 2025

(54) IMAGE FORMING APPARATUS, IMAGE FORMING METHOD, AND RECORDING MEDIUM

(71) Applicant: Konica Minolta, Inc., Tokyo (JP)

(72) Inventor: Yuki HOTATE, Tokyo (JP)

(73) Assignee: Konica Minolta, Inc., Tokyo (JP)

(21) Appl. No.: 18/738,317

(22) Filed: Jun. 10, 2024

(30) Foreign Application Priority Data
Jun. 27, 2023 (JP) 2023-104862

(51) Int. Cl. H04N 1/409; G03G 15/00; G03G 15/01

(52) U.S. Cl. CPC H04N 1/4092; G03G 15/0189; G03G 15/5029

(57) ABSTRACT

An image forming apparatus includes an image former that forms an image of a plurality of colors on a sheet by an intermediate transfer method on a basis of acquired image data, and a hardware processor that acquires sheet information of the sheet, extracts an edge from the image data, subjects the extracted edge to image processing according to the sheet information of the sheet, and causes the image former to form an image of a plurality of colors on the sheet on the basis of the image data subjected to the image processing.

### CROSS-REFERENCE STATEMENT

The present application is based on, and claims priority from, Japanese Patent Application Number 2023-104862, filed Jun. 27, 2023, the disclosure of which is hereby incorporated by reference herein in its entirety.

### BACKGROUND

### Technical Field

The present invention relates to an image forming apparatus, an image forming method, and a recording medium.

In recent years, a developer using an electrostatic charge image developing toner (hereinafter, simply referred to as “toner”) has become the main stream in copying machines and printers using an electrophotographic method. To be specific, an electrostatic charge image is formed on a photoreceptor with a laser, and the electrostatic charge image is developed with charged toner. The use of the toner enables high-speed development.

An image forming apparatus using toner has a problem of color misregistration. The problem is caused by misalignment of images of respective colors used for image formation.

Therefore, for example, the following contents are disclosed in JP 2017-032823A. As the basis weight, rigidity, and the like of the sheet increase, the torque fluctuation increases. Then, as a result of the increase in torque fluctuation, the degree of color misregistration also increases. Therefore, in the case of a sheet having a basis weight larger than a threshold, the color misregistration is corrected by suspending a print job and forming a test pattern. In addition, JP 2008-158076A discloses a configuration in which an amount of loop of a sheet is detected and controlled to be constant, thereby reducing color misregistration. In addition, JP 2016-103678A discloses a configuration in which a ratio of black monochromatization processing for a pixel of interest is determined according to distances between the pixel of interest and neighboring pixels of different colors to prevent white spotting. Furthermore, J P 2007-088781A discloses a configuration in which color misregistration is corrected by performing edge emphasis processing and edge correction processing on an image object.

### SUMMARY

However, the method of reducing color misregistration disclosed in JP 2017-032823A, JP 2008-158076A, JP 2016-103678A, and JP 2007-088781A requires time and effort for suspension of a job, detection of an amount of loop of a sheet, analysis of an image, and the like in order to reduce color misregistration. Therefore, it is required to reduce color misregistration more efficiently and effectively without taking time and effort.

The present invention has been made in view of such circumstances. It is an object of the present invention to provide an image forming apparatus, an image forming method, and a recording medium that can reduce color misregistration more efficiently and effectively.

To achieve at least one of the abovementioned objects, according to an aspect of the present invention, an image forming apparatus reflecting one aspect of the present invention includes: an image former that forms an image of a plurality of colors on a sheet by an intermediate transfer method on a basis of acquired image data; and a hardware processor that acquires sheet information of the sheet, extracts an edge from the image data, subjects the extracted edge to image processing according to the sheet information of the sheet, and causes the image former to form an image of a plurality of colors on the sheet on the basis of the image data subjected to the image processing.

To achieve at least one of the abovementioned objects, according to an aspect of the present invention, an image forming method reflecting one aspect of the present invention is: an image forming method for an image forming apparatus comprising an image former that forms a white background image of a plurality of colors on a sheet by an intermediate transfer method on a basis of image data acquired from an external device, the image forming method causing a hardware processor to perform: acquiring sheet information of the sheet; extracting an edge from the image data; subjecting the extracted edge to image processing according to the acquired sheet information of the sheet; and causing the image former to form an image of a plurality of colors on the sheet on the basis of the image data subjected to the image processing.

To achieve at least one of the abovementioned objects, according to an aspect of the present invention, a recording medium reflecting one aspect of the present invention is: a non-transitory computer-readable recording medium storing a program causing a computer of an image forming apparatus including an image former that forms a white background image of a plurality of colors on a sheet by an intermediate transfer method on a basis of image data acquired from an external device to perform: acquiring sheet information of the sheet; extracting an edge from the image data; subjecting the extracted edge to image processing according to the acquired sheet information of the sheet; and causing the image former to form an image of a plurality of colors on the sheet on the basis of the image data subjected to the image processing.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic diagram illustrating an example of a configuration of an image forming apparatus according to the present embodiment;

FIG. 2 is a block diagram illustrating a functional configuration of the image forming apparatus according to the present embodiment;

FIG. 3 is a flowchart of image forming processing according to the present embodiment;

FIG. 4 is a diagram illustrating an example of an edge extraction filter according to the present embodiment;

FIG. 5 is an example of a correspondence table between the sheet information and an edge change amount in the image forming processing according to the present embodiment;

FIG. 6 is an example of a correspondence table between the sheet information and inking start lightness in image forming processing according to the present embodiment;

FIG. 7A is a diagram illustrating an example of a case where a color misregistration occurs at a negative edge output without changing a line width;

FIG. 7B is a diagram illustrating an example of a case where color misregistration occurs at a negative edge output after a line width is increased;

FIG. 8A is a diagram illustrating an example of a print result in a case where inking is started from low lightness;

FIG. 8B is a diagram illustrating an example of a print result in a case where inking is started from high lightness; and

FIG. 9 illustrates an example of a correspondence table between sheet information and an edge change amount in image forming processing according to another embodiment.

### DETAILED DESCRIPTION

Hereinafter, one or more embodiments of the present invention will be described with reference to the drawings. However, the scope of the invention is not limited to the disclosed embodiments. In the following description, components having the same functions and configurations are denoted by the same reference numerals, and the description thereof will be omitted.

### [Overall Configuration of Image Forming Apparatus]

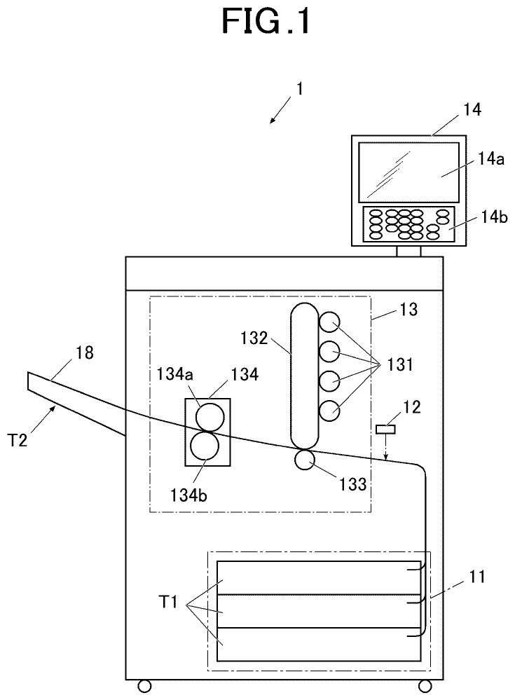

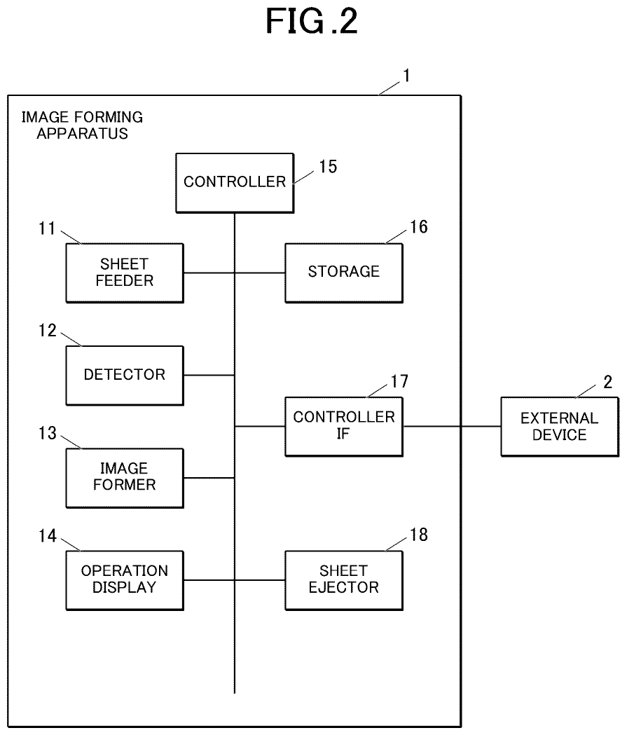

FIG. 1 is a diagram illustrating an example of a schematic configuration of an image forming apparatus 1. FIG. 2 is a block diagram illustrating a functional configuration of the image forming apparatus 1.

The image forming apparatus 1 is an apparatus that forms an image on a sheet P. As illustrated in FIG. 1, the image forming apparatus 1 includes a sheet feeder 11, a detector 12, an image former 13, an operation display 14, a controller 15 (hardware processor), a storage 16, a controller interface (controller IF) 17, and a sheet ejector 18.

### (Sheet Feeder)

The sheet feeder 11 includes a plurality of sheet feed trays T1. Sheets P are stored in the sheet feed trays T1. The sheets P stored in respective sheet feed trays T1 have different sheet information such as basis weight, sheet type, rigidity, and thicknesses. The sheet feeder 11 feeds a sheet P to the image former 13 through a predetermined conveyance path.

### (Detector)

The detector 12 detects sheet information of the sheet P conveyed from the sheet feeder 11. The detector 12 outputs the detected sheet information of the sheet P to the controller 15.

The detector 12 includes one or more sensors. The sensor detects sheet information of the sheet P. For example, the detector 12 includes an optical sensor including a light emitter and a light receiver. The light emitter irradiates the sheet P with light. Furthermore, the light receiver receives reflected light reflected by the sheet P. The detector 12 transmits a voltage value detected by the light receiver to the controller 15. The controller 15 acquires sheet information such as the basis weight and the sheet type of the sheet P from the voltage value received from the detector 12.

For example, the detector 12 includes an acceleration sensor. The acceleration sensor is provided on a contact body such as an elastically supported roller which is in contact with the sheet P to be conveyed. The detector 12 transmits the acceleration detected by the acceleration sensor to the controller 15. The controller 15 acquires the rigidity of the sheet P from the acceleration received from the detector 12.

For example, the detector 12 includes a displacement sensor that detects the thickness of the sheet P. Then, the controller 15 acquires the thickness of the sheet P from the detector 12.

### (Image Former)

The image former 13 forms a toner image by an electrophotographic method and transfers it onto the sheet P. The toner image is formed on the basis of image data input from an external device 2 such as a personal computer. As illustrated in FIG. 1, the image former 13 includes photosensitive drums 131 of respective colors and an intermediate transfer belt 132 as image bearing members. In the present embodiment, the photosensitive drums 131 form respective toner images of black (K), cyan (C), magenta (M), and yellow (Y).

The intermediate transfer belt 132 is an endless belt. The image former 13 winds the intermediate transfer belt 132 around a plurality of rollers and thus supports the intermediate transfer belt 132 so as to allow it to run.

The image former 13 forms a toner image with a color material (toner) of each color on the photosensitive drum 131 of each color. The image former 13 successively transfers the toner images formed onto the intermediate transfer belt 132. This enables the image former 13 to form a toner image including layers of respective colors superimposed on the intermediate transfer belt 132. The image former 13 applies a bias having a polarity opposite to that of the toner to the transfer roller 133 to transfer the toner image formed on the intermediate transfer belt 132 onto the sheet P. The number of the photosensitive drums 131 included in the image former 13 is not limited to four, and may be more or less than four. The image former 13 may further include, for example, a photosensitive drum 131 that forms a toner image of a special color (white (W) or the like).

The image former 13 includes a fixing unit 134. The fixing unit 134 fixes the toner image formed on the sheet P. As illustrated in FIG. 1, the fixing unit 134 includes a pair of rollers. The pair of rollers include a heating roller 134a and a pressure roller 134b. Then, the sheet P is held by the pair of rollers.

The fixing unit 134 heats the heating roller 134a to a predetermined temperature by a heater serving as a heating source. Furthermore, the fixing unit 134 biases the pressure roller 134b toward the heating roller 134a by an elastic member (not illustrated). The fixing unit 134 causes the sheet P, onto which the toner image has been transferred, to pass through a nip between the heating roller 134a and the pressure roller 134b. Through the control, the fixing unit 134 applies heat and pressure to the toner image to melt and fix the toner image on the sheet P.

### (Operation Display)

The operation display 14 includes a display 14a and an operation unit 14b. The display 14a includes a display screen. The display 14a displays various kinds of information on the display screen. The operation unit 14b is used for input of various instructions by a user.

### (Controller)

The controller 15 includes, for example, a central processing unit (CPU) and a random access memory (RAM). The CPU reads various programs such as a system program and a processing program stored in the storage 16 and deploys the programs to the RAM. The CPU executes various types of processing according to the deployed programs. The controller 15 controls the operation of the image former 13 so as to form an image on the sheet P on the basis of the image date received by the controller IF 17.

### (Storage)

The storage 16 includes, for example, a hard disk drive (HDD) and a semiconductor non-volatile memory. The storage 16 stores various programs such as a system program and a processing program executed by the controller 15, and data necessary for executing these programs.

### (Controller IF)

The controller IF 17 receives print job data input from the external device 2.

### (Sheet Ejector)

The sheet ejector 18 ejects, to a sheet ejection tray T2 outside the apparatus, the sheet P on which the image has been formed by the image former 13 and on which the fixing processing has been performed by the fixing unit 134.

### [Image Forming Processing]

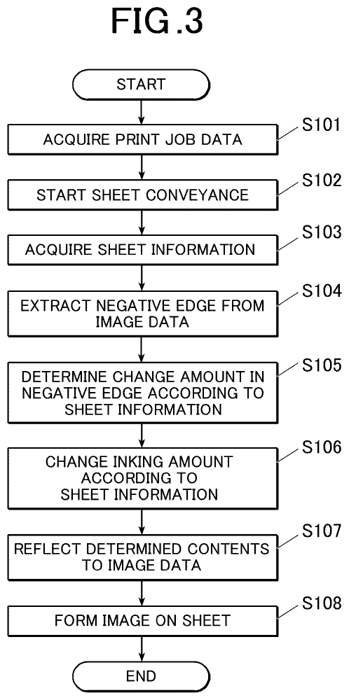

Next, image forming processing performed by the image forming apparatus 1 according to the present embodiment will be described with reference to a flowchart of FIG. 3. In the following, a case where a negative edge image is formed will be exemplified. The negative edge image is a so-called white background image. When a negative edge image is formed, the image former 13 forms a background image.

The controller IF 17 acquires print job data including image data from the external device 2 (step S101). When the controller IF 17 acquires the print job data, the controller 15 conveys the sheet P from the sheet feeder 11 to the image former 13 (step S102). The detector 12 detects sheet information of the sheet P being conveyed. Then, the controller 15 acquires the sheet information of the sheet P from the detector 12 (step S103). In this way, the controller 15 functions as an acquirer that acquires the sheet information of the sheet P.

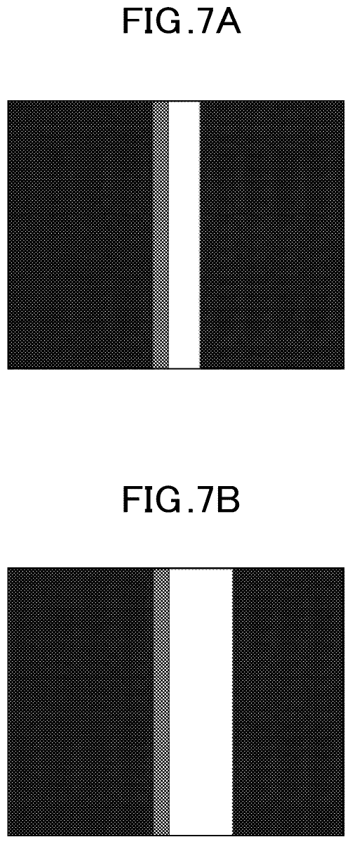

The controller 15 also extracts a negative edge from the received image data (step S104). An edge refers to a portion where a change in pixel value is equal to or greater than a certain value. Furthermore, the negative edge is a white line formed by a background of a plurality of colors as illustrated in FIG. 7A.

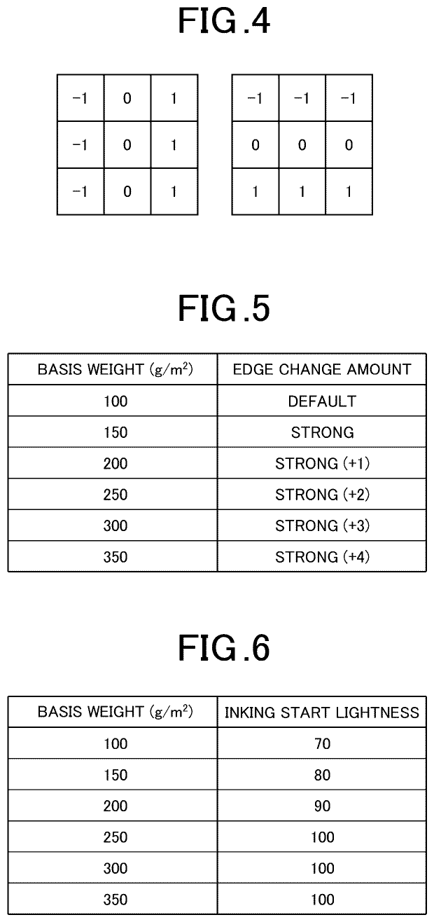

The controller 15 extracts the edge without limiting the direction by extracting and combining the edges separately in the vertical direction and the horizontal direction with respect to the image data by the edge extraction filter. Examples of the edge extraction filter include a Prewitt filter illustrated in FIG. 4. In this way, the controller 15 functions as an extractor that extracts an edge from the image data.

The controller 15 determines a change amount in the negative edge on the basis of the sheet information of the sheet P acquired in step S103 (step S105). To be specific, the change amount in the negative edge is determined on the basis of, for example, the table in FIG. 5. As illustrated in FIG. 5, in the present embodiment, as the basis weight of the sheet P increases, the thinning processing of the negative edge is enhanced (i.e., the negative edge is thickened).

The controller 15 determines an inking amount on the basis of the sheet information of the sheet P acquired in step S103 (step S106). The inking refers to forming dots with K toner on a color image formed with color toner such as YMC. The controller 15 determines the inking amount on the basis of, for example, the table in FIG. 6. As illustrated in FIG. 6, in the present embodiment, as the basis weight of the sheet P increases, the inking is started from high lightness. That is, in the present embodiment, when the basis weight of the sheet P is large, it is determined to increase the inking amount.

After determining the change amount in the negative edge and the inking amount, the controller 15 reflects these determined contents in the image data (step S107). In this way, the controller 15 functions as an edge corrector that subjects the extracted edge to image processing according to the sheet information of the sheet P. The controller 15 controls the image former 13 to form an image on the sheet P on the basis of the image date in which the determination contents are reflected (step S108). In this way, the controller 15 functions as an image formation controller that causes the image former 13 to form an image of a plurality of colors on the basis of the image data subjected to the image processing.

### Effects of Embodiment

As described above, the image forming apparatus 1 according to the present embodiment includes the image former 13 that forms an image of a plurality of colors on the sheet P by the intermediate transfer method on the basis of the acquired image data. The controller 15 of the image forming apparatus 1 according to the present embodiment also functions as an acquirer that acquires the sheet information of the sheet P. The controller 15 of the image forming apparatus 1 according to the present embodiment also functions as an extractor that extracts an edge from the image data. The controller 15 of the image forming apparatus 1 according to the present embodiment also functions as an edge corrector that subjects the extracted edge to the image processing according to the sheet information of the sheet P. The controller 15 of the image forming apparatus 1 according to the present embodiment also functions as an image formation controller that causes the image former 13 to form an image of a plurality of colors on the basis of the image data subjected to the image processing by the edge corrector. According to the above-described configuration, the controller 15 can efficiently and effectively reduce color misregistration on the basis of the acquired sheet information without suspending a job.

To be specific, the image forming apparatus 1 increases the line width of the negative edge when the basis weight and the rigidity of the sheet P are high, for example. This is because when the basis weight and the rigidity of the sheet P are high, torque fluctuation increases and color misregistration is likely to occur. FIG. 7A is a schematic diagram illustrating a negative edge with color misregistration, the negative edge being formed by a conventional image forming apparatus 1. FIG. 7B is a schematic diagram illustrating a negative edge with color misregistration, the negative edge being formed by the image forming apparatus 1 according to the present embodiment. As clearly seen from a comparison between FIG. 7A and FIG. 7B, according to the above-described configuration, the proportion of the color misregistration portion at the negative edge is relatively small. Therefore, the color misregistration can be made less conspicuous.

The image forming apparatus 1 increases the inking start lightness when the sheet information is acquired in which color misregistration is likely to occur.

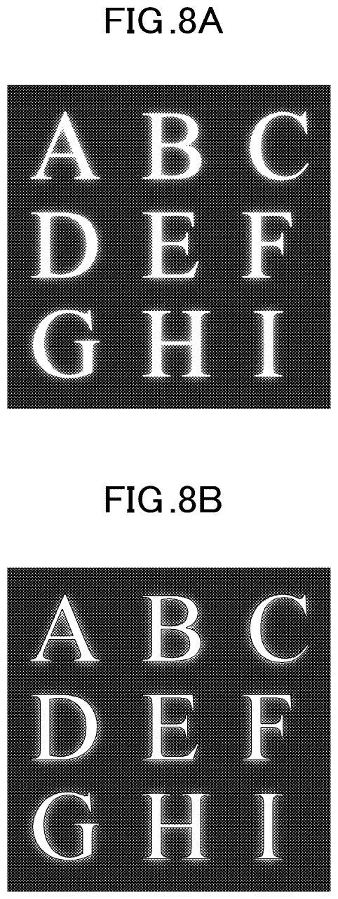

FIG. 8A is a diagram illustrating an example of a print result in a case where the conventional image forming apparatus 1 performs inking from low lightness (lightness 70). FIG. 8B is a diagram illustrating an example of a print result in a case where the image forming apparatus 1 according to the present embodiment performs inking from high lightness (lightness 100). As clearly seen from a comparison between FIG. 8A and FIG. 8B, according to the above-described configuration, the lightness of the color misregistration portion can be lowered, and the color misregistration can be made less conspicuous.

### [Other Configurations]

Note that the description in the above embodiment is an example of the image forming apparatus 1 according to the present invention, and the present invention is not limited thereto. The detailed configuration and detailed operation of each unit constituting the image forming apparatus 1 can also be appropriately changed without departing from the spirit of the present invention.

For example, in the above description, the case where the detector 12 includes various sensors has been exemplified, but the present invention is not limited thereto. For example, when the received print job data includes designation of the sheet P, the sheet information may be detected on the basis of the designation. In this case, the controller 15 functions as the detector 12.

In the above description, the case where the background image is formed by the image former 13 to form a white background image and the negative edge is extracted has been exemplified, but the present invention is not limited thereto. The present invention is also applicable to a case where a so-called black background image is formed by the image former 13 and a positive edge is extracted.

In the above description, the case where the print job data is received from the external device 2 has been exemplified, but the invention is not limited thereto. The image forming apparatus 1 may have a scanning function, and in this case, may receive print job data according to a user's operation on the operation unit 14b.

In the above description, the case where the change amount in the negative edge is also increased as the basis weight of the sheet P increases has been illustrated in FIG. 5, but the present invention is not limited thereto. In a case where a color misregistration amount is enough to cover the entire negative edge, the color misregistration portion may erode the entire negative edge. When the change amount in the negative edge is increased in such a case, the color misregistration may be conspicuous.

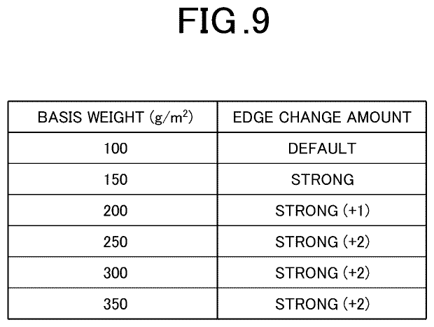

Therefore, when the basis weight of the sheet P reaches a predetermined value, the change amount in the negative edge does not need to be increased any more. For example, FIG. 9 illustrates a case where, when the basis weight of the sheet P reaches 250 g/m², the change amount in the negative edge is not increased any more.

In a case where the table as illustrated in FIG. 9 can be adopted, it is preferable that a user can arbitrarily select whether to adopt the table illustrated in FIG. 5 or the table illustrated in FIG. 9. To be specific, it is preferable that a user performs test printing once, determines whether the currently selected table is appropriate, and can change the table by operation on the operation unit 14b.

In FIGS. 5, 6, and 9, the case where only the basis weight of the sheet Pis referred to as the sheet information has been exemplified, but the present invention is not limited thereto. For example, the paper type, rigidity, thickness, and the like of the sheet P may be referred to. Alternatively, a plurality of ones of the basis weight, the paper type, the rigidity, and the thickness may be referred to in combination.

In the above description, the configuration in which the change amount in the edge and the inking start lightness are determined on the basis of the correspondence table with the sheet information has been exemplified, but the present invention is not limited thereto. For example, a configuration may be adopted in which a function relating to the relationship between the sheet information and the change amount in the edge or the relationship between the sheet information and the inking start lightness is calculated in advance, and the change amount in the edge and/or the inking start lightness is calculated from the function.

In the above description, the configuration in which the change amount in the edge and the inking start lightness are automatically determined and changed on the basis of the sheet information has been described, but the present invention is not limited thereto. Before step S107 of reflecting the determined contents to the image data, a step of obtaining user's approval for the change amount in the edge and the inking start lightness may be performed.

In the above description, the configuration in which both of the change amount in the edge and the inking start lightness are changed according to the sheet information has been exemplified, but only one of them may be changed. Alternatively, a configuration may be adopted in which whether to change only one of the change amount in the edge and the inking start lightness or whether to change both of them is selected on the basis of a user's instruction.

In the above description, the configuration in which the controller 15 of one image forming apparatus 1 controls image formation of the image forming apparatus 1 has been exemplified, but the present invention is not limited thereto. For example, a plurality of image forming apparatuses 1 may be connected to form different images on a single sheet P. In addition, in the above-described configuration, another image forming management apparatus including the controller 15 that controls the plurality of image forming apparatuses 1 may be provided.

In the above description, an example in which a hard disk, a semiconductor non-volatile memory, or the like is used as a computer-readable medium for the program according to the present invention has been disclosed, but the medium is not limited to this example. As another computer-readable medium, a portable recording medium such as a CD-ROM can be applied. A carrier wave is also applied as a medium for providing data of the program according to the present invention via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus, comprising:
an image former that forms an image of a plurality of colors on a sheet by an intermediate transfer method on a basis of acquired image data; and
a hardware processor that acquires sheet information of the sheet,
extracts an edge from the image data,
subjects the extracted edge to image processing according to the sheet information of the sheet, and
causes the image former to form an image of a plurality of colors on the sheet on the basis of the image data subjected to the image processing.

2. The image forming apparatus according to claim 1, wherein
the image former forms a white background image of a plurality of colors on the sheet, and
the hardware processor extracts a negative edge from the image data, and changes a line width of the negative edge according to the sheet information on the sheet.

3. The image forming apparatus according to claim 2, wherein
the sheet information includes basis weight or rigidity of the sheet, and
the hardware processor increases the line width of the negative edge according to the basis weight or the rigidity of the sheet.

4. The image forming apparatus according to claim 3, wherein the hardware processor performs the image processing on a basis of a correspondence table between the sheet information of the sheet and a change amount in the line width of the negative edge.

5. The image forming apparatus according to claim 1, wherein the hardware processor changes lightness at which inking is started according to the sheet information of the sheet.

6. The image forming apparatus according to claim 3, wherein the hardware processor changes lightness at which inking is started according to the sheet information on the sheet, and increases the lightness at which inking is started according to the basis weight or the rigidity of the sheet.

7. The image forming apparatus according to claim 1, further comprising:
a detector that detects the sheet information of the sheet, wherein
the hardware processor acquires a detection result by the detector.

8. The image forming apparatus according to claim 1, wherein the hardware processor extracts an edge from the image data by an edge extraction filter.

9. An image forming method for an image forming apparatus comprising an image former that forms an image of a plurality of colors on a sheet by an intermediate transfer method on a basis of image data acquired from an external device, the image forming method causing a hardware processor to perform:
acquiring sheet information of the sheet;
extracting an edge from the image data;
subjecting the extracted edge to image processing according to the acquired sheet information of the sheet; and
causing the image former to form an image of a plurality of colors on the sheet on the basis of the image data subjected to the image processing.

10. A non-transitory computer-readable recording medium storing a program causing a computer of an image forming apparatus including an image former that forms an image of a plurality of colors on a sheet by an intermediate transfer method on a basis of image data acquired from an external device to perform:
acquiring sheet information of the sheet;
extracting an edge from the image data;
subjecting the extracted edge to image processing according to the acquired sheet information of the sheet; and
causing the image former to form an image of a plurality of colors on the sheet on the basis of the image data subjected to the image processing.
